(19) United States
(12) Patent Application Publication
(10) Pub. No.: US 2019/0248965 A1
(43) Pub. Date: Aug. 15, 2019

(54) ADDITIVE FOR THE CONTROLLED ADJUSTMENT OF THE VISCOSITY OF POLYMERS

(71) Applicant: L. BRÜGGEMANN GmbH & Co. KG, Heilbronn (DE)

(72) Inventor: Klaus Bergmann, Heilbronn (DE)

(73) Assignee: L. BRÜGGEMANN GmbH & Co. KG, Heilbronn (DE)

(21) Appl. No.: 16/342,025

(22) PCT Filed: Oct. 16, 2017
(86) PCT No.: PCT/EP2017/001218

§ 371 Date: Apr. 15, 2019

(30) Foreign Application Priority Data
Oct. 17, 2016 (EP) 16002226.5

(51) Int. Cl. C08J 3/22; C08K 5/092; C08L 77/02; C08L 77/06; C08L 77/10; C08L 67/02; B29C 45/00

(52) U.S. Cl. CPC C08J 3/226; C08K 5/092; C08L 77/02; C08L 77/06; C08L 77/10; B29K 2077/00; B29C 45/0001; C08L 2310/00; C08L 2205/025; C08L 2205/03; C08L 2201/08; C08L 67/02

(57) ABSTRACT

The present invention concerns an additive for the controlled viscosity adjustment of polycondensates, comprising an acid and/or acid anhydride and a carrier, preferably a polymeric carrier, characterized in that the acid and/or the acid anhydride is uniformly distributed in the carrier, a process for preparing the additive, a process for the controlled viscosity adjustment of polycondensates and the use of the additive for the controlled viscosity adjustment of polycondensates.

The present invention concerns an additive for the controlled viscosity adjustment of polymers containing acid-cleavable units, in particular polycondensates such as polyamides, polyesters, polycarbonates and polyethers and their copolymers, a process for the preparation of the additive, a process for the controlled viscosity adjustment of polymers, comprising acid-cleavable units, in particular polycondensates, such as polyamides, polyesters, polycarbonates and polyethers, and copolymers thereof, and the use of the additive for the controlled viscosity adjustment of polymers comprising acid-cleavable units, in particular polycondensates, such as polyamides, polyesters, polycarbonates and polyethers, and copolymers thereof.

### BACKGROUND TO THE INVENTION

Polyamides are plastics with a wide range of applications. Molded parts made from polyamides or polyamide compounds are usually produced by injection molding or extrusion. In injection molding, the plastic is injected from a plasticizer, which heats the plastic to the melting temperature, into a mold in which it is first compressed and then cooled. During extrusion, the plastic passes through a dosing device into a heated cylinder, where it is melted, homogenised and compressed, before being pressed through a nozzle by means of a screw. This line is called extruder. Extruders are used for the production of profiles, pipes, sheets, textile fibres, containers and masterbatches.

Polyamides processed in injection molding should have a higher melt flow index (MFI) than polyamides used as thermoplastic extrusion compounds. Extrusion compounds usually have a higher molecular mass and thus a higher melt viscosity or a lower melt index compared to injection molding compounds made of the same materials. Higher melt viscosities or lower melt indices enable, among other things, better stability after leaving the die during extrusion. Higher molar mass, higher melt viscosity or reduced melt index are also typically associated with improved mechanical values. However, processing by injection moulding is more difficult. In practice, therefore, lubricants/process aids are usually added to improve the processability in injection moulding in order to enable an adequate property profile in injection moulding. The most frequently used process aids in polyamides include metal stearates, amide waxes, fatty acid esters of long-chain alcohols and montan waxes (montanic acid, its esters and metal salts), which are used depending on the required profile. Particularly in the case of reinforced polyamides, very high concentrations of these lubricants must be used in this context, especially for higher filler contents (e.g. 30 to 60%), in order to ensure good processability both during the compounding step and during injection moulding. Disadvantages are in particular efflorescence on the surface of moulded parts, significant impairment of the mechanical properties and increased additive costs.

Similar tasks and problems also exist for users of other polycondensates, such as polyesters, polycarbonates and polyethers. Particularly with polyesters, users only have relatively narrow processing windows at their disposal, which require precise process control and also precise control of the product quality of the starting material.

Polycondensates, such as polyamides and the other polymers mentioned here, in particular polyesters, are rapidly and strongly degraded in the melt by the addition of acids or acid anhydrides at high temperatures. This principle is used for the chemical recycling of polyamide 6. (E. Meusel, E. Seifert, E. Taeger, Chemical recycling of polyamide interlinings, rubber fibers, plastics 1998, 51(2) pages 126 to 130). This article describes that polyamide can be partially degraded in the melt with dicarboxylic acids to oligo- or polyamide dicarboxylic acids. The degree of degradation is determined by the mixing ratio of the components. The aliphatic dicarboxylic acid initially attacks the more basic amino end groups, and the molecular chains are also cleaved. The splitting is subject to statistical rules and thus fragments of different chain lengths are produced. The fission products can then be converted with aliphatic diamines into products which are good hot-melt adhesives due to their melting behaviour and viscoelastic properties.

Polyamides with lower chain lengths exhibit better flowability. High flowability and low melt viscosity are desirable properties for injection molding applications.

However, chain degradation by acids is difficult to control due to the high reaction rates in the melt and leads to a significant deterioration of the mechanical properties. Furthermore, the control of such reactions becomes more difficult when polyamide starting materials are used which have an unspecified composition and/or initial viscosity, e.g. mixed production waste and/or recycling materials. Such materials are therefore not used for the production of high-quality products, as targeted viscosity adjustment would require extensive preliminary investigations and test runs.

WO-A-01/21712 concerns polyamide compositions in which organic acids are incorporated to reduce viscosity without significantly reducing toughness. In particular, WO-A-01/21712 describes reinforced polyamide compositions comprising 40 to 94% by weight of polyamide, 6 to 60% by weight of a reinforcing agent selected from the group consisting of rubber and ionic copolymers and up to 10% by weight of an organic acid. For production, polyamide, reinforcer and organic acids are mixed together in one step in the melt or a mixture of polyamide and reinforcer is mixed with the acid in the melt or polyamide and reinforcer are mixed and then mixed with the acid in the melt. The result is a reinforced polyamide with increased flowability and reduced melt viscosity without negatively affecting toughness.

However, chain degradation by acids is difficult to control due to the high reaction rates in the melt and can therefore lead to a deterioration of the mechanical properties. WO-A-01/21712 also concerns rubber-reinforced polyamides. It is necessary that the rubber contains a functional group that can react with the end groups of the polyamide. Furthermore, it is necessary that the melt viscosities of the rubber and the polyamide are similar in order to obtain a good dispersion.

D. Lehmann, Polymers-Opportunities and Risks II: Sustainability, Product Design and Processing 2010, 12, 163-192 describes the melt modification of polyamides to oligoamides. Degradation reactions in the melt are described. The degradation takes place again by the addition of carboxylic acids or carboxylic acid anhydrides. After the addition of the degradation compound to a polyamide melt at a temperature above 230° C., a rapid decrease in melt viscosity can be observed after a short time. Oligoamides with a defined molecular weight and a narrow molecular weight distribution are obtained.

K.-J. Eichhorn, D. Lehmann, D. Voigt, Journal of Applied Polymer Science 1996, Vol. 62, pages 2053-2060, describe that long polymer chains can be rapidly degraded during an extrusion process to low molecular weight functionalized polymers and oligomers. The studies were performed with PA6 and trimellitic anhydride. Two different reaction mechanisms were observed. The first was a reaction of the anhydride with amino end groups of PA6, the second a reaction of the anhydride with amide groups of PA6 with chain cleavage. However, a mixture of different degradation and reaction products was obtained during this reaction.

The unreinforced polyamides with good flow properties available on the market are essentially produced in comparatively small quantities by chemical modification during polymerization in batch processes. The large mass of polyamides produced by continuous hydrolytic polymerization cannot easily achieve these flow properties.

So far, no really efficient flow improvers are known for non-reinforced polyamides. The known agents only improve the flow properties of filled polyamides (often by modifying the surface of the fillers, for example with coupling agents, in order to achieve a flow improvement), but in unreinforced polyamides they have little or no effect at all.

### TASK OF THE INVENTION

The task of the present invention is to solve the above-mentioned problems of the state of the art and to provide an additive with which a controlled lower viscosity adjustment or a positive influence on the flow properties, in particular a lengthening of the flow spiral, is possible, in order to improve the flowability of polycondensates, in particular of non-reinforced and reinforced polyamide and polyester, while at the same time maintaining the mechanical characteristics such as tensile strength, flexural strength, impact strength and elongation at break. A further task of the present invention is to effectively and reproducibly adjust the flowability for use in high-quality injection moulding applications with a very good mechanical property profile, even in the case of high-molecular polycondensates (polyester, polyamides, etc.) which do not conform to specifications, and to thus prepare them. Another task of this invention is to effectively and reproducibly adjust the flowability of high-molecular polycondensates (polyester, polyamides, etc.) from wastes for use in high-quality injection molding applications and to process them. The waste mentioned may originate from the production, processing and recycling of polyamide materials. Furthermore, the waste may originate from the production, processing and finishing of cast polyamide 6. Furthermore, it is a task of the present invention not only to adjust the flowability of pure high-molecular polycondensates (polyester, polyamides, etc.) but also of mixtures of high-molecular polycondensates (polyester, polyamides, etc.) effectively and reproducibly for use in high-quality injection moulding applications and thus to prepare them.

### SHORT DESCRIPTION OF THE INVENTION

These tasks are solved by an additive for controlled viscosity adjustment according to claim 1, comprising an acid and/or acid anhydride and a preferably polymeric carrier, characterized in that the acid and/or acid anhydride is uniformly distributed in the carrier and does not react or reacts only insignificantly with the polymeric carrier.

The task is also solved by a process for preparing the additive according to claim 12, preferably comprising introducing the acid or acid anhydride into a polymeric carrier in the melt and uniformly distributing the acid and/or acid anhydride in the polymeric carrier.

The task is also solved by a process for the controlled viscosity adjustment of polycondensates. For example, the polycondensate and the invention additive can either be melted and mixed together, or the polycondensate is melted first and then the invention additive is mixed in, the latter being the preferred variant.

The task of the present invention is also solved by the use of the additive.

Preferred embodiments are shown in subclaims 2 to 11 and 15 to 17.

### DESCRIPTION OF THE FIGURES

FIG. 1 shows the changes in the relative viscosities of different polyamides with the addition of adipic acid, both with the additive according to the invention and with comparative additives as well as with direct addition. FIG. 2 shows GPC spectra of materials from example 4.

### DETAILED DESCRIPTION OF THE INVENTION

Surprisingly, it was possible to solve the problem of the present invention by introducing at least one acid or an acid anhydride with chain-cleaving action into a carrier, preferably a polymeric carrier, with which this acid or the acid anhydride does not react or reacts only insignificantly, in the melt and distributing it uniformly in the polymeric carrier in a first step in the case of polymers which have acid-cleavable units, in particular polycondensates, such as polyamides, polyesters, polycarbonates and polyethers and their copolymers, and in particular in the case of polymers which have acid-cleavable units, such as polyamides, polyesters, polycarbonates and polyethers and their copolymers. This additive, comprising the very well distributed acid (or acid anhydride) in the carrier, can then be mixed in the melt with the polymer to be modified.

By premixing the acid or the acid anhydride in a carrier, preferably a polymeric carrier, it is unexpectedly achieved that in the subsequent processing with the polycondensate melt the melt components can be mixed very intensively and uniformly homogeneously in a narrow residence time distribution and brought to reaction. This unexpectedly results in polycondensates, in particular polyamides and polyesters with specifically shortened chains with a defined narrow molecular weight distribution. It is assumed that the viscosity of the polymers, preferably polyamides and polyesters, can be controlled and precisely adjusted to the desired point by this targeted chain shortening.

This invention shows an astonishing suitability for adjusting the flowability/viscosity without adversely affecting other properties of the starting material. In the examples according to the invention as well as in FIG. 1 the exact adjustment possibility of the target viscosity is shown by the linear dependence between modification of the flowability/viscosity and application quantity of additive. Furthermore, as shown in FIG. 2 in particular, the inventive additive allows a change in flowability/viscosity without adversely affecting the width or modality of the molecular weight distribution and the PDI (polydispersity index) of the starting material. For the characterization of polymers averaged values are given as molecular mass. The number-average molar mass (Mn) and the weight-average molar mass (Mw) are commonly used. Polydispersity (PDI) is a measure of the width of the molecular weight distribution. Polydispersity is defined as the quotient of Mw and Mn (PDI=Mw/Mn). The number-average molecular weights Mn and the weight-average molecular weights Mw can be determined by gel permeation chromatography (GPC). In particular, neither splitting nor widening of the molecular mass distribution with an associated increase in the PDI takes place, nor are larger amounts of low-molecular material formed. This is illustrated by comparing the molecular mass distributions for the samples R35 and R37 (after compounding, called “R37 before injection moulding” in FIG. 2), where a parallel shift of the molecular mass distribution curve can be seen. In addition, the use of the additive in accordance with the invention does not lead to any further significant change in the material in subsequent injection moulding applications. This is illustrated by the two molar mass distribution curves R37 (after compounding, called “R37 before injection moulding” in FIG. 2) and R37 (after injection moulding), where there is no noticeable change in the material. This is a particularly important feature for the injection moulding user, since the parameters of the starting material (after compounding) determine the parameters of the finished product.

Further advantages and aspects of this invention are described below. Insofar as this description refers to polyamides, the expert will understand that these embodiments can also be applied to other polymers already described here which have acid-cleavable units, in particular polycondensates such as polyamides, polyesters, polycarbonates and polyethers as well as their copolymers. The description of the preferred embodiments with reference to polyamides only serves the purpose of legibility and simplification of the description. However, all the embodiments described also refer to the other polymers mentioned here and are disclosed for them.

Surprisingly, the inventive additive has the following further advantages:
Due to the improved flowability of the polyamide, a reduction in cycle times and thus an improvement in productivity can be achieved in the injection moulding process. The improved flowability also allows the temperature during injection moulding to be lowered, which reduces energy consumption and reduces holding pressure and cooling times. Alternatively, the temperature can of course remain unchanged, so that shorter cycle times can be achieved thanks to the improved flow properties. Typically, however, an injection moulding user will use the advantages of this invention to reduce the processing temperature, since the material is less thermally stressed during injection moulding. Due to the improved flow behaviour, more complex and/or thinner-walled products can also be produced, since especially long flow paths, complex geometries and the filling of thin-walled areas are possible without problems. Thus, the field of application of the modified polyamides according to the invention expands, especially of polyamides filled with glass fibers or other fillers and reinforcing materials, so that further components previously made of metal can now be replaced by polyamides modified according to the invention.
The invention opens up the possibility of completely dispensing with commonly used lubricants. In many cases, these can cause adverse effects and problems as they migrate to the surface as foreign components in polyamides. This can, for example, impair paintability or printability. In addition, mold coatings can form on tool surfaces, which must be removed at great expense.
By specific combinations of known lubricants and/or demoulding agents with additives according to the invention achieves an even further improvement of the processing and flow properties can be achieved.
The basic principle of the present invention can be used for the production of composite materials. These often have the problem of high melt viscosity with correspondingly low flowability of the polymer melt, so that the fibre mats cannot be infiltrated and penetrated properly or the limited flowability only permits the production of small composite components.
The opportunity is provided to produce components with lower wall thicknesses compared to current counterparts with comparable mechanical properties. Due to the thinner wall thickness, weight savings are achieved within the framework of lightweight construction concepts. New designs with longer and/or more complex flow geometries are possible.
Thanks to the improved flowability, multi-cavity moulds can be used, which can lead to higher production rates and corresponding cost reductions. Since the polyamides produced according to the invention require a lower injection pressure, smaller injection moulding machines can also be used, which are cheaper to purchase and operate.
High-viscosity polyamide waste (e.g. from packaging films or extrusion applications) from production waste or used materials can be converted into fast-flowing injection moulding qualities, which enable with respect to flowability of the melt and mechanical properties the same quality as with virgin material. This applies in particular to highly viscous polyester waste, e.g. from PET, which is generated during bottle production or recycling of PET bottles.
High-viscosity cast polyamide waste can be processed into high-quality PA6 injection molding grades and extrusion grades using the invention's additives. There is a great economic need in this area, since the processing of cast polyamide 6 can generate waste quantities of up to 10% of the polyamide mass during the manufacture of semi-finished products (e.g. through sprues and distribution systems). In addition, further quantities of waste are generated by machining and fluctuations in production, so that up to 30% of the polyamide material used for a component can end up as waste. Within the EU alone, this corresponds to an estimated waste volume of 5000 tonnes/year.
The additive according to invention shows a good and controllable activity even with unreinforced polyamides, so that even with unreinforced polyamides a controlled viscosity adjustment and at the same time a significantly increased flowability can be achieved without negatively influencing the mechanical properties.
By using the carrier material, in particular a polymeric carrier material, a possible corrosive effect of the acids or anhydrides on the steel elements of the apparatus used for mixing in the melt is also significantly reduced compared to the direct incorporation of an acid into a polyamide.

In accordance with the invention, the term “evenly distributed” means that the acid or acid anhydride is distributed in the carrier, preferably the polymeric carrier, in such a way that the concentration in all parts of the carrier, preferably the polymeric carrier, is essentially the same, i.e. that there are no sites in the carrier which have a significantly higher concentration of additive than other sites. The term “homogeneously distributed” may be used interchangeably.

In principle, all substances (or mixtures of substances), preferably polymers, which can be mixed with the acid or the acid anhydride at a temperature in the melt at which both the acid or the acid anhydride and the carrier are stable, i.e. neither decompose nor react with each other, nor contain or form volatile components and, furthermore, as far as possible do not discolour, can be considered as carriers. Acid (or acid anhydride) and carrier should be selected so that either acid (or acid anhydride) and carrier both are mixed in the molten state or that the acid (or acid anhydride) can be completely dissolved in the molten carrier. Thus a homogeneous mixture of the acid or the acid anhydride in the carrier can be achieved by mixing in the melt.

In a preferred version in combination with one of the above or below mentioned embodiments, the carrier is a polymeric carrier with which the polyamide to be modified is compatible and very well miscible. Furthermore, the polymeric carrier is thermally stable preferably at the processing temperatures typical for polyamides, contains or forms as few volatile components as possible and does not discolour during processing. In another version, the carrier contains reactive groups that can react with the polyamide in a similar way to the homogeneously distributed carboxylic acid it contains. These may be copolymers containing maleic anhydride or glicydyl methacrylates with olefins. Examples are ethylene-ethyl acrylate-glycidyl methacrylate terpolymer (E-EA-GMA), ethylene-butyl acrylate-glycidyl methacrylate terpolymer (E-BA-GMA), ethylene-vinyl acetate copolymer functionalized with maleic anhydride (E-VA-MA), styrene-ethylene-butylene-styrene copolymer functionalized with maleic anhydride (SEBS-MA). These polymeric carriers with reactive groups are preferably used in combination with non-reactive polymeric carriers (without reactive groups), whereby good miscibility must be ensured.

Preferably the polymeric support is selected from a polymer or copolymer of the monomers ethylene, propylene or other olefins, methacrylic acid, vinyl acetate, acrylic acid, acrylic acid ester, or methacrylic acid ester. The polymeric carrier is particularly preferably an olefin-acrylic acid ester copolymer or an olefin-methacrylic acid ester copolymer, in particular an ethylene-methylacrylate copolymer (EMA), an ethylene-ethyl acrylate copolymer (EEA) or an ethylene-butyl acrylate copolymer (EBA).

As mentioned above, non-polymeric carriers can also be used. Examples are lubricants such as primary and secondary fatty acid amide waxes, for example ethylene bis-stearamide (EBS), erucamide and stearamide, metal soaps such as metal stearates, paraffin waxes, polyolefin waxes, Fischer-Tropsch waxes, Fatty acid esters of pentaerythritol, polar synthetic waxes (e.g. oxidized polyolefin waxes or grafted polyolefin waxes) or other waxes, as well as other substances also known as additives for polyamides. Preferred are EBS, erucamide, long-chain esters of pentaerythritol and oxidized polyolefin waxes.

In a preferred configuration, the carrier, preferably a polymeric carrier, ideally has a melting point lower than the melting point of the polyamide to be processed. On the one hand, this enables the gentle and energy-saving introduction of the acid or anhydride into the carrier during the manufacture of the additive according to the invention, and on the other hand, it also simplifies the introduction into the polyamide. Overall, the thermal load on the acid or anhydride and the carrier material is thus minimised.

The carrier can also be mixed with one or more other polymers which, in contrast to the carrier to be used according to the invention, which does not react or reacts only insignificantly with the acid or anhydride used, can react with the acid component contained. The proportion of such additional (reactive) polymers is 50% by weight or less, in particular less than 30% by weight, based on the total composition of the additive. In any case, the proportion must not be higher than the proportion of non-reactive carrier, preferably 50 wt. % or less, more preferably 40 wt. % or less, and in forms of implementation 30 wt. % or less, based on the proportion of non-reactive, preferably polymeric carrier. Suitable polymers for this design can be freely selected, if necessary taking into account the intended area of application (of the polyamide to be modified). Polyamides such as polyamide 6 and polyamide 6.6 and their blends, as well as polyesters such as PET and PBT and their blends, or blends of polyamides and polyesters are particularly suitable. By partially replacing the non-reactive carriers, cost savings can be realized and/or the miscibility/processability with the polyamides to be modified can be improved. Investigations with additives containing polyamide have surprisingly shown that the use of a polyamide in the additive itself can improve the impact strength of the end product.

In a preferred form of implementation in combination with one of the above or below mentioned embodiments, the acid and/or the acid anhydride is a carboxylic acid or a carboxylic anhydride, in particular preferably a polyfunctional carboxylic acid, in particular a bifunctional carboxylic acid. Monocarboxylic acids, dicarboxylic acids, tricarboxylic acids, tetracarboxylic acids etc. as well as aminocarboxylic acids or mixtures of the above can be used. In particular, the bifunctional carboxylic acid is selected from the group consisting of adipic acid, pimelic acid, cork acid, azelaic acid, sebacic acid, undecandicarboxylic acid, dodecandicarboxylic acid, oxalic acid, malonic acid, succinic acid, glutaric acid, oxaloacetic acid, phthalic acid, terephthalic acid, isophthalic acid, 2,6-naphthalenedicarboxylic acid or mixtures thereof, and derivatives of these dicarboxylic acids. Adipic acid, sebacic acid and terephthalic acid are particularly preferred. An example of a particularly suitable derivative of one of the dicarboxylic acids mentioned are succinic acid derivatives, e.g. 2-(10Oxo-10H-9-oxa-10-phosphaphenantren-10-ylmethyl)succinic acid.

Also suitable are polymers or oligomers that are acid-terminated (i.e. have acid end groups), such as polyamides, oligoamides and polyesters, especially acid-terminated oligomeric amides. Suitable acid-terminated polymers are in particular polyamide 6, polyamide 6.6, PBT and PET and blends of these polymers or blends of these polymers and these oligomers. Such higher molecular acids, which can be used in accordance with the invention, can typically be mixed well with the carrier materials and, especially the oligomeric amides, also exhibit good compatibility and miscibility with the polyamides to be modified.

In another preferred embodiments in association with one of the above or below mentioned embodiments, the acid anhydride is selected from trimellitic anhydride, succinic anhydride, phthalic anhydride, pyromellitic anhydride or mixtures thereof, particularly preferably the acid anhydride is trimellitic anhydride.

The use of anhydrides has shown that it is advantageous to ensure that a certain amount of moisture is present in the reaction system during the modification of polyamides. This moisture can be introduced specifically with the additive according to the invention or can, for example, be present as residual moisture in the polyamide. It is assumed that when moisture is present, the anhydrides are converted into the corresponding acids, which then represent the reactive species during modification.

In another preferred form in combination with one of the above or below mentioned forms different carboxylic acids and acid anhydrides can be used in the mixture, especially mixtures of trimellitic anhydride with terephthalic acid or isophthalic acid are preferred.

In another preferred form in combination with one of the above or below mentioned forms, the polymeric carrier has a melting temperature less than or equal to the melting point of the polyamide to be modified.

According to the invention, all common polyamides can be used. Polyamides are polymers with recurring carbonamide groups —CO—NH— in the main chain. They are formed from
(a) aminocarboxylic acids or their functional derivatives, e.g. lactams; or from
(b) diamines and dicarboxylic acids or their functional derivatives.

By varying the monomer building blocks, polyamides are available in a wide variety. The most important representatives are polyamide 6 from £ caprolactam, polyamide 6.6 from hexamethylene diamine and adipic acid, polyamide 6.10 and 6.12, polyamide 10.10, polyamide 12.12, polyamide 11, polyamide 12, PACM-12 as well as polyamide 6-3-T, PA4.6, partially aromatic polyamides (polyphthalamides PPA) and the aromatic polyamides (aramides).

According to the invention, all other polyamides can also be used, for example copolyamides or copolymers of polyamides with other polymers, for example with polyesters. It is also possible to use blends of different polyamides and blends of polyamides with other polymers. Polyamide 6 and polyamide 6.6 are particularly preferred.

The additive according to the invention can be used in all previously mentioned polyamides and blends, both in unfilled and unreinforced polyamides as well as in filled and reinforced polyamides. As fillers/reinforcing materials glass fibres, carbon fibres, glass balls, diatomaceous earth, fine-grained minerals, talcum, kaolin, phyllosilicates, CaF₂, CaCO₃ and aluminium oxides can be used.

The polyamide is in a preferred form in combination with one of the above or below mentioned forms selected from unreinforced, PA6, PA6.6, PA4.6, PA11 or PA12, particularly preferred is unreinforced PA6 or PA6.6.

In another preferred form in combination with one of the above or below mentioned forms, the polyamide is selected from reinforced PA6, PA6.6, PA4.6, PA11 or PA12, more preferably the polyamide is a glass fibre reinforced polyamide, in particular PA6 or PA6.6, reinforced with 20 to 70% by weight of glass fibres, such as about 30 to 50% by weight.

With regard to the other polymers that can be used according to the invention, there is also no restriction. These can be in particular polyester, polycarbonates and polyethers, as well as copolymers thereof (also copolymers with polyamides). These polymers can also be provided with fillers and/or reinforcing materials and fibres, as has already been described for polyamides. Other preferred polymers are in particular polyesters, such as PET, PBT and their copolymers, in particular highly viscous PET (bottle grade).

In a further preferred embodiments in combination with one of the above or below mentioned forms of implementation, the acid and/or the acid anhydride or mixtures thereof is contained in an amount of 1 to 50% by weight, particularly preferably 5 to 33% by weight, in particular 8 to 30% by weight, based on the total amount of the additive. In embodiments, the acid and/or the acid anhydride is present in quantities of 10 to 27% by weight, such as 10, 11, 12, 13, 14, 15, 16, 17, 18, 19, 20, 21, 22, 23, 24, 25, 26 or 27% by weight. The above mentioned quantity, based on weight percent, is typically sufficient, even taking into account the fact that the acids or anhydrides to be used according to the invention have different molecular weights and different numbers of acid groups. An alternative way of defining the acid or acid anhydride content of the invention additive is therefore to define the molar amount of acid groups per kilogram of additive. In this context, molar amounts of acid groups (from the acid component or anhydride component of the additive in accordance with the invention) of about 0.1 mol/kg to about 6 mol/kg of additive, preferably 0.5 to 5 mol/kg of additive, more preferably 0.8 to 3 mol/kg of additive, are suitable in accordance with the invention.

In another preferred form in combination with one of the above or below mentioned forms, the inventive additive further contains at least one additive selected from the group consisting of antioxidants, nucleating agents, stabilizers, lubricants, mold release agents, slip enhancers, fillers, colorants, flame retardants and flame protecting agents, plasticizers, impact modifiers, antistatics, processing aids, polyols and their derivatives, as well as other polymers usually compounded with polyamides or mixtures thereof. Preferably the additive contains antioxidants, polyols or derivatives thereof, nucleating agents and/or lubricants. This allows both the modifying additive and the further additives required for the desired end application to be introduced into the polyamide in a single processing step. This simplifies polyamide processing, as additional mixing processes and mixing stages can be omitted.

Suitable antioxidants are secondary aromatic amines, phosphites, organic sulfides such as thioesters, copper salts and copper complexes (in combination with halogen-containing synergists) and sterically hindered phenols (typically in combination with phosphites or other secondary antioxidants).

Suitable nucleating agents are inorganic compounds, e.g. talcum, pyrogenic silicas, kaolin; organic compounds, e.g. Salts of mono- or polycarboxylic acids, such as calcium stearate or montanate, lithium montanate, sodium benzoate, aluminium tert-butyl benzoate, salts of adipic acid, dibenzylidene sorbitols and derivatives thereof, salts of phosphonic esters; oligomers and polymers, e.g. oligomers of caprolactam, polyamide 2.2.

Suitable lubricants and lubricity improvers are long-chain fatty acids and their derivatives, e.g.: Fatty acid amides, stearic acid, stearic acid salts, stearates; fatty alcohols and their esters; paraffin waxes; polyolefin waxes, e.g. polyethylene waxes and polar polyethylene waxes; montan waxes, e.g. based on esters, partially saponified esters, montanic acid; amide waxes; modified hydrocarbon waxes and molybdenum disulfide.

Suitable polyols and derivatives thereof are polyols or their ether or ester derivatives, in particular polyhydric alcohols or their ether or ester derivatives, which are known as heat stabilizers and flame retardants. Such additives have proven to be surprisingly effective components in this invention, increasing the flowability unexpectedly without reducing the mechanical properties. Well-known examples of such compounds are polyols with 2 to 12 hydroxyl groups and a molecular weight of 64 to 2000 g/mol. Particularly suitable examples are aliphatic polyols with 3 or more —OH groups, such as pentaerythritol, dipentaerythritol, tripentaerythritol and ether or ester derivatives of these compounds, in particular dipentaerythritol.

Such polyols or derivatives thereof can be easily introduced into the additive according to the invention by known means. Surprisingly, the introduction of these polyols (in particular dipentaerythritol) as a component of the additive enables significantly reducing the undesired formation of deposits on the molded parts compared to the direct addition of the polyol during processing.

Further examples of these additives are as follows:

Dye: Titanium dioxide, lead white, zinc white, liptone, antimony white, carbon black, iron oxide black, manganese black, cobalt black, antimony black, lead chromate, red lead, zinc yellow, zinc green, cadmium red, cobalt blue, Berlin blue, ultra man, Manganese violet, cadmium yellow, Schweinfurt green, molybdenum orange and red, chrome orange and red, iron oxide red, chrome oxide green, strontium yellow, molybdenum blue, chalk, ochre, umbra, green earth, Terra di Siena burnt and graphite.

Flame retardants and flame protecting agents: antimony trioxide, hexabromocyclododecane, tetrachloro- or tetrabromobisphenol and halogenated phosphates, borates, chlorinated paraffins, red phosphorus. Other halogen-free flame retardants and flame protecting agents are also suitable, in particular melamine cyanurate, melamine polyphosphate and aluminium diethylphosphinate (DEPAL).

Fillers: glass fibres, carbon fibres, glass balls, diatomaceous earth, fine-grained minerals, talcum, kaolin, layered silicates, CaF₂, CaCO₃, aluminium oxides, etc.

Mould release agents and processing aids: Waxes (montanates), montanic acid waxes, montanester waxes, polysiloxanes, stearates, polyvinyl alcohol, SiO₂, calcium silicates.

Impact modifiers: polybutadiene, EPM, EPDM, HDPE, butyl acrylates, MAH-functionalized polymers, functionalized olefin-acrylate copolymers, etc.

Antistatics: Carbon black, polyhydric alcohols, fatty acid esters, amines, acid amides, quaternary ammonium salts.

These additives can be used in the usual quantities known to the professional. According to the invention, it is possible to incorporate the additives into the additive according to the invention, so that one additive already includes all necessary modifiers and additives during the production of molded parts from polyamide. Alternatively, a different approach is also possible, i.e. mixing in all or some of the desired additives via separate additives, which are also added to the manufacturing process at different points (at different temperatures). In this context, it must certainly also be taken into account to what extent the different additives are compatible with the additive according to the invention, in particular the acid or the acid anhydride, since undesired side reactions in the additive itself must of course be excluded. The specialist can produce suitable designs on the basis of his common knowledge.

Inventive additives particularly preferably comprise an acid component, preferably adipic acid or terephthalic acid, in an amount of 7 to 25% by weight, together with an olefin-acrylic acid ester copolymer, or olefin-methacrylic acid ester copolymer in an amount of more than 40% by weight (based on the weight of the additive mixture), preferably in an amount of more than 65% by weight. In embodiments, there is admixed another reactive polymer, as described above, preferably a polyamide, such as PA6, or a polyester, such as PBT. This additional component is preferably present in this mixture in an amount of 10 to 30 wt. %, more preferably 15 to 25 wt. % (based on the weight of the additive mixture).

In a preferred configuration in combination with one of the above or below mentioned configurations, the acid and/or acid anhydride is introduced into the carrier, preferably a polymeric carrier, in the melt and uniformly distributed in the melt in a mixing device such as an extruder. Further suitable mixing devices as well as suitable process parameters are known to the expert. The processing temperature in the extruder should preferably be above the melting point of the respective acid(s). The mixture obtained in the first step is added to the polyamide in the melt, preferably in an extruder. The preferred temperature in the extruder is 100 to 300° C., especially 220 to 270° C. The expert can select suitable process parameters, in particular temperatures, based on his common knowledge. Depending in particular on the polyamide to be processed, processing temperatures in the range from 240° to 270° C., but also temperatures in the range from 220° to 240° C. can be suitable. These can be selected by the specialist, as described above, on the basis of the usual process parameters.

The inventive process according to claim 13 comprises mixing the additive with a polyamide material in a conventional mixing device such as an extruder. The inventive process also includes the use of the additive with a polyamide material as a granulate mixture or as a dry blend in injection molding. Depending on the starting material and the additive composition, process parameters, such as in particular the temperature, are set on the basis of standard procedures known to experts. The quantity of additive is selected in such a way that a desired target viscosity, flowability (flow path length, e.g. of a flow spiral in injection moulding) is achieved, for which a few orientation tests may be necessary (however, due to the linear dependence of the viscosity modification on the quantity of additive (quantity of acid), this is only a routine task). It has been shown that additive amounts (based on the acid groups acid or anhydride) in the range from 0.001 to 0.5 mol/kg (amount based on mixture with polyamide), such as 0.005 to 0.15 or 0.01 to 0.1 mol/kg, are sufficient to achieve the desired viscosity adjustment/flowability adjustment. Of course, other quantities can be selected in special cases. The present invention thus enables a targeted viscosity adjustment/adjustment of the flowability by adding the additive. As the torque decreases during extrusion, the throughput can be increased. In addition, application studies have shown that when using the additive according to the invention, not only does the torque decrease, but the course of the torque shows less strong deflections/changes. This indicates a better, more homogeneous processing and mixing of the material, which can lead to better products and/or avoid rejects.

Semi-aromatic polyamides are typically processed at high temperatures. Furthermore, there are stringent requirements regarding long-term stability at elevated temperatures. Therefore, it is important with such polyamides that the acids are chosen in such a way that they outgas as little as possible. In addition to good compatibility, this is an important reason for the preferred use of aromatic carboxylic acids in the inventive modification of semi-aromatic polyamides. Similar considerations also apply to high viscosity polyesters, in particular PET, which also require high processing temperatures and only provide a narrow processing window. In another preferred form, higher molecular carboxylic acids, especially aromatic carboxylic acids, are used, either directly by selecting an aromatic carboxylic acid with a high molecular weight (e.g. 2,6-naphthalenedicarboxylic acid) or by in-situ formation of higher molecular carboxylic acids during the production of an additive according to the invention. This can be achieved by adding reactive polymers in addition to the non-reactive polymeric carrier. These reactive polymers are preferably polyamides or polyesters (e.g. PBT, PC, polybutyrates, polycaprolactone etc.). Thus, higher molecular reaction products can be obtained which have the necessary acid or anhydride groups and show little or no tendency to outgassing in view of the higher processing temperatures during the modification of semi-aromatic polyamides.

Especially when the viscosity of a partially aromatic polyamide has to be adjusted, additives based on aromatic carboxylic acids as acid components are preferred. In another preferred design form in combination with one of the above or below mentioned designs, one (or more) aromatic carboxylic acid, preferably an aromatic dicarboxylic acid, particularly preferably terephthalic acid, can be added as acid.

The innovative additive is easy to use and shows excellent behavior in injection molding processes due to faster cycle times and improved flow behavior. The polyamides obtained according to the invention have good mechanical properties and improved impact strength.

The following examples illustrate this invention:

### Methods:

Compounding was carried out on a twin screw extruder from Leistritz (ZSE27MAXX—48D). The torque of the extruder was recorded in percent. A value is also obtained for the current consumption per kg compound as specific energy [kWh/kg]. The addition of adipic acid in the production of Additive 1, Additive 2 and Additive 3 as well as the addition of terephthalic acid in the production of Additive 4 and Additive 5 and the addition of the additives to polyamides according to the examples was carried out gravimetrically directly during compounding.

After drying, “Demag Ergotech 60/370-120 concept” standard test rods (thickness 3 mm) were produced from the compound on an injection moulding device for determining the mechanical properties (ISO 527), impact strength (ISO 179/1eA) and flow spirals produced using a campus tool. The production of flow spirals by injection moulding was also carried out directly from polyamide and from a granulate mixture of polyamide and additive in accordance with the invention.

Elastic modulus [MPa], tensile strength [MPa] (elongation [%]) and breaking stress [MPa] (elongation at break [%]) were measured in a tensile test according to ISO 527 using a Zwick Z010 static materials testing machine.

The impact strength was measured according to ISO 179/1eA in the Charpy notched bar impact test with a pendulum impact tester HIT PSW 5.5J.

The length of the flow spiral was measured in cm.

GPC measurements to determine the polydispersity and mean molecular masses (Mn and Mw) were performed under the following measurement conditions: column combination PSS PFG, 7 μm, LINEAR M, ID 8.0 mm×300 mm, PSS PFG, 7 μm, LINEAR M, ID 8.0 mm×300 mm, temperature 23° C., hexafluoroisopropanol (HFIP)/0.05 M potassium trifluoroacetate as mobile phase, flow rate 1 ml/min, sample concentration 3.0 g/I, differential refractometer (RID)-detector, evaluation against poly(methyl methacrylate)-standard.

The relative viscosity (RV) was determined in 96% sulphuric acid according to ISO 307. In this method, the solution viscosity of the polyamide was determined as the relative viscosity in sulphuric acid in the Ubbelohde viscometer using a ViscoSystem® AVS 470.

### Additives:

| Proportion [wt. %] | Additive 1 | Additive 2 | Additive 3 |
|---|---|---|---|
| adipic acid | 8 | 12 | 12 |
| Ethylene-methyl acrylate | 92 | 88 | 69 |
| copolymer | | | |
| Polyamide 6 | | | 19 |

Additives 1 and 2 were each produced on a Leistritz ZSE 27 MAXX 48D twin-screw extruder at 100° C. to 180° C. (in a corresponding temperature profile) with a throughput of 18 kg/h. The additives were then extruded on a Leistritz ZSE 27 MAXX 48D twin-screw extruder. Additive 3 was also produced with the aforementioned extruder, at temperatures of 180° C. to 250° C. and a throughput of 15 kg/h.

### Comparative Additive 1:

2% adipic acid in 98% polyamide 6 (Ultramid B27 from BASF) was extruded on a Leistritz ZSE 27 MAXX 48D twin-screw extruder at 260° C. with a throughput of 15 kg/h.

### Comparative Additive 2:

8% adipic acid in 92% polyamide 6 (Ultramid B27 from BASF) was extruded on a Leistritz ZSE 27 MAXX 48D twin-screw extruder at 260° C. with a throughput of 15 kg/h.

### Example 1

Additive 1 and comparative additive 1 were incorporated into a viscous polyamide 6 (Alphalon 32 from Grupa Azoty) and extruded once or twice with a Leistritz ZSE 27 MAXX 48D twin-screw extruder at 260° C. with a throughput of 15 kg/h.

The following compounds were produced:

TABLE 1

| | | | Comparative | |
|---|---|---|---|---|
| | Polyamide 6 | Additive 1 | additive 1 | |
| | [% by weight] | [% by weight] | [wt.-%] | extrusions |
| R01 | 100 | | | 1 |
| R02 | 100 | | | 2 |
| R03 | 98 | 2 | | 1 |
| R04 | 98 | 2 | | 2 |
| R05 | 98 | | 2 | 1 |
| R06 | 98 | | 2 | 2 |
| R07 | 97 | | 3 | 1 |
| R08 | 97 | | 3 | 2 |

Mass pressure, torque of the extruder, viscosity of the compounds and viscosity after injection moulding were investigated on the test specimens. The length of the flow spiral was also determined.

The results are presented in Table 2.

TABLE 2

| | | | | Relative | |
|---|---|---|---|---|---|
| | | Mass | Relative | viscosity | Spiral |
| | Torque | pressure | viscosity | Injection | length |
| | [%] | [bar] | Compound | moulding | [cm] (%) |
| R01 | 78 | 20 | 3.28 | 3.3 | 34.6 (100) |
| R02 | 70 | 20 | 3.29 | 3.28 | 35.7 (103.18) |
| R03 | 56 | 17 | 3.05 | 2.98 | 49.2 (142.20) |
| R04 | 48 | 15 | 2.97 | 2.9 | 49.1 (141.91) |
| R05 | 74 | 20 | 3.15 | 3.15 | 41.1 (118.79) |
| R06 | 52 | 20 | 3.16 | 3.13 | 40.9 (118.21) |
| R07 | 73 | 20 | 3.14 | 3.11 | 40.9 (118.21) |
| R08 | 63 | 18 | 3.11 | 3.08 | 39 (112.72) |

When processed in the extruder, the compounds according to the invention show a significant reduction in torque and a decrease in melt pressure, which leads to easier processability and higher throughput. Furthermore, these compounds show a decrease in relative viscosity and an increase in the length of the flow spiral.

In addition, the viscosity of compounds that have been extruded once decreases only slightly in all variants during the second extrusion. The same applies to the change in viscosity after injection moulding.

### Example 2

In a further trial, additive 1 and comparative additive 2 were incorporated into a viscous polyamide 6 (Alphalon 32 from Grupa Azoty) and extruded once with a Leistritz ZSE 27 MAXX 48D twin-screw extruder at 260° C. with a throughput of 15 kg/h. The following compounds were produced:

TABLE 3

| | | | Comparative |
|---|---|---|---|
| | Polyamide 6 | Additive 1 | additive 2 |
| | [% by weight] | [% by weight] | [wt.-%] |
| R09 | 100 | | |
| R10 | 99 | 1 | |
| R11 | 98 | 2 | |
| R12 | 97 | 3 | |
| R13 | 99 | | 1 |
| R14 | 98 | | 2 |
| R15 | 97 | | 3 |

Torque of the extruder, specific energy and relative viscosity of the compounds were determined.

The results are presented in Table 4.

TABLE 4

| | Torque Extruder | Specific Energy | Relative |
|---|---|---|---|
| | [%] | [kWh/kg] | viscosity |
| R09 | 85 | 1.77 | 3.22 |
| R10 | 65 | 1.55 | 3.15 |
| R11 | 63 | 1.54 | 3.09 |
| R12 | 61 | 1.47 | 3.02 |
| R13 | 85 | 1.76 | 3.18 |
| R14 | 83 | 1.75 | 3.16 |
| R15 | 81 | 1.73 | 3.13 |

In the inventive examples R10 to R12, the increasing dosage of additive 1 results in a significant reduction of the torque, which leads to simpler processability and higher throughput.

Furthermore, the relative viscosity of compounds R10 to R12 has decreased.

In the comparative examples R13 to R15, despite increasing dosage of comparative additive 2, only a very slight decrease in torque compared with compounding R10 to R12 (with additive of the invention) is found, so that processability is not improved and a higher throughput is not possible.

If R11 is compared with R14 and R12 with R15, a stronger decrease in viscosity can be measured with the same dosage of additive 1 or comparative additive 2 with the addition of additive 1, i.e. the reactivity of the additive according to the invention is much higher with the same dosage. Furthermore, there is a linear dependence of the relative viscosity of the compounds modified according to the invention with the amount of additive.

### Example 3

Additives 1, 2 and 3 and, in comparison, calcium montanate as the usual high-quality lubricant for polyamides were extruded with a polyamide 6 of injection molding quality (Tarnamid T27 from Grupa Azoty) together with different glass fiber contents (ChopVantage® HP3540 from PPG Industries Fiber Glass) as in example 1 and the relative viscosity and mechanical properties were determined.

The following compounds were produced:

TABLE 5

| | Poly- | | | | | |
|---|---|---|---|---|---|---|
| | amide | Glass | Additive | Additive | Additive | calcium |
| | 6 | fibers | 1 | 2 | 3 | montanate |
| | [% by | [% by | [% by | [% by | [% by | [% by |
| | weight] | weight] | weight] | weight] | weight] | weight] |
| R16 | 70 | 30 | | | | |
| R17 | 69.65 | 30 | 0.35 | | | |
| R18 | 69.3 | 30 | 0.7 | | | |
| R19 | 68.6 | 30 | 1.4 | | | |
| R20 | 67.9 | 30 | 2.1 | | | |
| R21 | 66.85 | 30 | | | 2.1 | |
| R21- | 66.85 | 30 | | 2.1 | | |
| A | | | | | | |
| R22 | 50 | 50 | | | | |
| R23 | 49.75 | 50 | 0.25 | | | |
| R24 | 49.5 | 50 | 0.5 | | | |
| R25 | 49 | 50 | 1 | | | |
| R26 | 48.5 | 50 | 1.5 | | | |
| R27 | 69.65 | 30 | | | | 0.35 |
| R28 | 69.3 | 30 | | | | 0.7 |
| R29 | 68.6 | 30 | | | | 1.4 |
| R30 | 67.9 | 30 | | | | 2.1 |
| R31 | 49.75 | 50 | | | | 0.25 |
| R32 | 49.5 | 50 | | | | 0.5 |
| R33 | 49 | 50 | | | | 1 |
| R34 | 48.5 | 50 | | | | 1.5 |

The results are presented in Table 6. Empty cells within the table mean that the values were not determined.

An exact comparison of the examples and comparative examples once again demonstrates the advantages of the present invention. For the tests with a glass fiber content of 30%, the results for R17 to R21 on the one hand (inventive) must be compared with the results for R27 to R30. The respective raw material is represented by R16. In the tests in accordance with the invention, the flow spiral was significantly extended (36.1 cm to 47.3 cm), while in the comparative tests only a negligible improvement in flowability occurred (36.1 cm to 37.8 cm). On the other hand, in the comparative tests the mechanical property profile drops drastically, while in the inventive tests it remains at an extraordinarily high level. The same tendency can also be seen in the tests with a glass fiber content of 50% (R23 to R26 are inventive, R31 to R34 are comparative tests). The raw material is represented by R22. Here, too, this invention shows a clear improvement in flowability while maintaining the good mechanical property profile, effects which are far from being achieved in the comparative tests.

Here it can be seen that by using the additive according to the invention, it is also possible to adjust the viscosity of glass fiber-filled polyamides without a drop in the mechanical properties. This allows such modified filled (reinforced) polyamides to be processed very well, especially in injection molding. On the other hand, the use of a conventional lubricant shows only a slight improvement in the flow properties, and important mechanical parameters drop. In addition, lubricants can lead to efflorescence. The inventive examples further show that by improving the flow properties (flow spiral) polyamide types are obtained which can be processed well and reliably. It was also shown that an additive with a certain proportion of a reactive polymer, in this example R21 a polyamide 6, mixed with the non-reactive polymeric carrier also allows the desired modification. Surprisingly, the additional polyamide content not only results in a somewhat longer flow spiral compared to the example of R21-A (analog additive without polyamide content), but also in a higher notched bar impact strength and higher elongation. Furthermore, the amount of non-reactive polymeric carrier can be reduced, which can bring advantages in terms of miscibility and possibly costs. Thanks to their good processability, filled compounds produced with additives according to the invention allow the safe filling of thin-walled areas or large, complex parts. As an additional option, processing temperatures in injection molding can be reduced by up to 30° C., which shortens cooling times and reduces energy consumption. The easier flow also reduces the required injection pressure, so that producers can produce more gently or on smaller machines. Since polyamide filled with glass fiber is now used in many areas in which metal components have previously been used, such improvements are an important step towards the further substitution of complex metal structures by much lighter and cheaper injection molded parts, some of which are highly integrated (compared with metal components).

TABLE 6

| | | | | | | Notched bar | |
|---|---|---|---|---|---|---|---|
| | Relative | flow | tensile | ultimate | modulus of | impact | Impact |
| | viscosity (after | spiral | strength | elongation | elasticity | toughness | strength |
| | compounding) | [cm] | [MPa] | [%] | [Mpa] | kJ/m2 | kJ/m2 |
| R16 | 2.75 | 36.1 | 195 | 6 | 9640 | 12.95 | 90.06 |
| R17 | 2.72 | 36.9 | 192 | 5.9 | 9510 | 12.39 | 86.14 |
| R18 | 2.68 | 39.9 | 190 | 5.8 | 9530 | 12.64 | 86.52 |
| R19 | 2.62 | 44.3 | 187 | 5.7 | 9430 | 12.67 | 83.98 |
| R20 | 2.57 | 47.3 | 187 | 5.6 | 9450 | 12.73 | 84.39 |
| R21 | 2.49 | 48.8 | 192 | 7 | 9240 | 14.16 | |
| R21- | 2.62 | 48.0 | 183 | 6.0 | 9620 | 12.63 | |
| A | | | | | | | |
| R22 | 2.71 | 25.1 | 231.9 | | 15780 | 18.33 | 92.8 |
| R23 | 2.66 | 27.4 | 230.7 | | 16079 | 17.6 | 88.75 |
| R24 | 2.60 | 28.9 | 233.8 | | 16248 | 17.44 | 91.08 |
| R25 | 2.54 | 32.6 | 229.5 | | 15995 | 17.26 | 88.94 |
| R26 | 2.49 | 36.7 | 227.7 | | 15656 | 17.26 | 86.23 |
| R27 | 2.76 | 35.0 | 186 | 5.5 | 9520 | 11.62 | 73.12 |
| R28 | 2.74 | 36.1 | 178 | 5.1 | 9540 | 9.88 | 59.66 |
| R29 | 2.72 | 37.2 | 177 | 5.2 | 9510 | 10.13 | 60.86 |
| R30 | 2.72 | 37.8 | 175.0 | 5.1 | 9540 | 10.04 | 57.62 |
| R31 | 2.73 | 25.7 | 225.1 | | 15508 | 17.44 | 84.75 |
| R32 | 2.70 | 27.0 | 215.2 | | 16042 | 15.82 | 74.56 |
| R33 | 2.71 | 26.4 | 215.3 | | 15913 | 15.74 | 71.96 |
| R34 | 2.70 | 26.5 | 211.0 | | 15712 | 16.4 | 76.4 |

### Example 4

A regranulate of highly viscous PA6.6 production wastes (highly viscous fibre wastes) was extruded together with additive 2 as described in example 1 and the relative viscosities and mechanical properties were determined. At the same time, a commercial polyamide 6 (Ultramid A27 from BASF with a relative viscosity of 2.7) was processed directly on the injection molding machine and the corresponding flowability and mechanical data was determined. Table 7 summarises the compositions.

TABLE 7

| | Regranulate | | PA6.6 New goods |
|---|---|---|---|
| | from fibre | | Ultramid A27 |
| | waste PA6.6 | | injection moulding |
| | high viscosity | Additive 2 | quality |
| | [%] | [%] | [%] |
| R35 | 100 | 0 | 0 |
| R36 | 98 | 2 | 0 |
| R37 | 96 | 4 | 0 |
| R38 | 0 | 0 | 100 |

This again shows that even when using an unspecified polyamide (the exact characteristic values of the regranulate were not known at the time of the test), exact control of the viscosity adjustment with the additive according to the invention is possible, where again a linear dependence of the viscosity development on the additive quantity could be observed. Such linear dependencies simplify dosing, since no complex dependencies have to be taken into account. In addition, it is shown once again that the important mechanical parameters are not deteriorated (but rather improved in some cases), so that a high-quality “injection-moulded polyamide” is obtained after compounding with the additive in accordance with the invention (Table 8). This can be seen in particular from the fact that the property profile achieved with the aid of the additive according to the invention as well as the flowability (length of the flow spiral) achieved with it in this example exceed the properties of the high-quality commercial injection molding grade Ultramid A27 in several respects.

TABLE 8

| | Relative | | | Elongation @ | | Notched bar | | | |
|---|---|---|---|---|---|---|---|---|---|
| | viscosity (before | flow | tensile | tensile | modulus of | impact | | | |
| | injection | spiral | strength | strength | elasticity | toughness | Mn GPC | Mw GPC | GPCPDI |
| | moulding) | [cm] | [MPa] | [%] | [MPa] | kJ/m2 | [Mn/Da] | [Mw/Da] | [Mw/Mn] |
| R35 | 3.19 | 38.5 | 84.9 | 5.3 | 3340 | 4.19 | 33800 | 89500 | 2.65 |
| R36 | 2.92 | 53.39 | 83.2 | 5.4 | 3320 | 5.12 | | | |
| R37 | 2.7 | 56.72 | 81.4 | 5.6 | 3300 | 4.78 | 28000 | 68000 | 2.43 |
| R38 | 2.7 | 54.44 | 84.7 | 5.5 | 3100 | 3.08 | 32400 | 73500 | 2.27 |

The GPC data and the GPC curves shown in FIG. 2 also show that this invention allows a change in flowability/viscosity without adversely affecting the molecular weight distribution of the starting material. In particular, there is no significant broadening of the molecular mass distribution, nor are large amounts of low molecular weight material formed. This is illustrated by the comparison of the molecular mass distributions for the samples R35 and R37, where essentially a parallel shift of the molecular mass distribution curve can be seen. In addition, the use of the additive in accordance with the invention does not lead to any further significant change in the material in subsequent injection moulding applications. This is illustrated by the two molar mass distribution curves R37 (after compounding, in FIG. 2 called “R37 before injection moulding” and R37 (after injection moulding), where no noticeable change in the material occurs.

The GPC data for the material after injection molding are: Mw 64400 Da, Mn 28100 Da and PDI 2.29. This shows that there is no significant further reaction (and possibly associated deterioration of the material properties) since, for example, the value for Mn of the injection moulded part is 28100 Da (compared to a value for Mn of 28000 Da for the material after compounding).

### Example 5

Adipic acid was incorporated in various concentrations into a viscous polyamide 6 (Alphalon 32 from Grupa Azoty) and extruded in a Leistritz ZSE 27 MAXX 48D twin-screw extruder at 260° C. with a throughput of 15 kg/h and the relative viscosity was determined. In addition, additive 1 was introduced into the same polyamide 6 as in example 3 and incorporated as described there without the addition of glass fibers and the relative viscosity was determined. Furthermore, different concentrations of additive 1 were compounded with the same regranulate from fibre waste as described in example 4 and the relative viscosity was measured.

The relative viscosities determined are assigned in Table 9 to the acid concentrations used for the production of the respective additive or to the concentrations of adipic acid for direct addition. The acid concentrations are given in % by weight based on the polyamide content in the finished polyamide compound. Empty cells within a row mean that the corresponding additive was not produced with the adipic acid concentration indicated in the row. In addition, Table 9 summarizes the measured relative viscosities from the following previous examples: Example 2 (additive 1 and comparative additive 2 in viscous PA6), example 3 (additive 1 in PA6 with injection molding quality with 30% GF and with 50% GF) and example 4 (additive 2 in regranulate from fiber waste).

In Table 9, for example, 0.04% by weight of adipic acid corresponds to the dosage of 0.35% by weight of Additive 1 from Example 3 (R17), or to the dosage of 0.25% by weight of Additive 1 from Example 3 (R23). 0.08 wt. % adipic acid correspond for example to the dosage of 1 wt. % additive 1 from example 2 (R10), or to the dosage of 0.7% additive 1 from example 3 (R18), or to the dosage of 0.5% additive 1 from example 3 (R24), etc. The results from Table 9 are shown graphically in FIG. 1.

As can be seen from FIG. 1, the viscosity changes linearly when the additive according to the invention is added, i.e. the relative viscosity decreases with increasing amount of additive. No linear decrease in relative viscosity was observed when using reference additives 1 and 2 and when using adipic acid alone. In addition, the effect of the reduction in viscosity is significantly lower with the comparative additives. Only the additive according to the invention allows a controlled and reproducible adjustment of the viscosity.

TABLE 9

| | | | Relative | | | | |
|---|---|---|---|---|---|---|---|
| | Relative | Relative | viscosity with | Relative | Relative | Relative | Relative viscosity with |
| | viscosity with | viscosity with | comparative | viscosity with | viscosity with | viscosity with | additives 1 and 2* in |
| Adipic acid [% | additive 1 in | adipic acid | additive 2 in | additive 1 in | additive 1 in | additive 1 | regranulate from fibre |
| by weight] | PA6 | directly in PA6 | PA6 | PA6GF50 2.7 | PA6GF30 2.75 | in PA6 2.75 | wastes PA6.6 |
| at 0% adipic | 3.22 | 3.25 | 3.22 | 2.71 | 2.75 | 2.75 | 3.19 |
| acid | | | | | | | |
| at 0.04% | | | | 2.66 | 2.72 | 2.72 | |
| adipic acid | | | | | | | |
| at 0.08% | 3.15 | | 3.18 | 2.6 | 2.68 | 2.70 | |
| adipic acid | | | | | | | |
| at 0.12% | | | | | | | 3.06 |
| adipic acid | | | | | | | |
| at 0.16% | 3.09 | | 3.16 | 2.54 | 2.62 | 2.66 | 3.02 |
| adipic acid | | | | | | | |
| 0.2% adipic | | 3.05 | | | | | 2.99 |
| acid | | | | | | | |
| 0.24% adipic | 3.02 | | 3.13 | 2.49 | 2.57 | 2.63 | 2.93* |
| acid | | | | | | | |
| 0.4% adipic | | 2.97 | | | | | |
| acid | | | | | | | |
| 0.48% adipic | | | | | | | 2.7* |
| acid | | | | | | | |
| 0.8% adipic | | 2.69 | | | | | |
| acid | | | | | | | |

### Example 6

A commercial heat-stabilized polyamide 6 with 30% glass fibers for injection molding (Durethan BKV 30 H2.0 from Lanxess) was mixed with Additive 2 in granulate form and this mixture was directly processed into flow spirals by injection molding. The results were compared to the direct processing of the same polyamide without additive 2. The melt temperature was 260° C., the mold temperature 90° C., and the injection speed 240 mm/s. The length of the flow spiral was measured in cm, the relative viscosity was determined on the material of the flow spiral. Table 10 summarizes the compositions and measured values.

TABLE 10

| | Polyamide 6 | | | |
|---|---|---|---|---|
| | (Durethan BKV | | | |
| | 30 H2.0) | Additive 2 | spiral length | Relative |
| | [% by weight] | [% by weight] | [cm] (%) | viscosity |
| R39 | 100 | | 40.20 (100.00) | 2.74 |
| R40 | 98.6 | 1.4 | 48.25 (120.02) | 2.52 |

Here it can be seen that the relative viscosity is also reduced in a targeted manner and the flowability (length of the flow spiral) is significantly improved when the additive according to the invention is used directly in the form of a mixture of the additive in granulate form with a polyamide granulate in injection molding. Despite the short mixing times during injection moulding, the additive according to the invention surprisingly shows excellent suitability for modifying the flow properties of the material to be processed in injection moulding. The spiral length increases significantly and the viscosity decreases, so that the advantages of the invention already discussed above can also be fully exploited in injection moulding. Even when used directly in injection moulding, cycle times can be increased, processing temperatures lowered and/or thinner-walled parts can be produced reliably. Alternatively, a dry blend, i.e. a powder mixture of the invention additive and the polyamide, can be produced and injection moulded.

### Example 7

Additive 4 was produced on a Leistritz ZSE 27 MAXX 48D twin-screw extruder at 100° C. to 180° C. (in a corresponding temperature profile) with a throughput of 18 kg/h. Additive 5 was also produced with the aforementioned extruder, at temperatures of 160° C. to 250° C. and a throughput of 15 kg/h.

| Share [wt. %] | Additive 4 | Additive 5 |
|---|---|---|
| terephthalic acid | 12 | 12 |
| Ethylene-methyl acrylate | 88 | 69 |
| copolymer | | |
| polybutylene terephthalate | | 19 |

Additive 2, Additive 4 and Additive 5 were extruded with the partially aromatic polyamide Novadyn™ DT/DI from INVISTA with a relative initial viscosity of 1.96 and the glass fiber ChopVantage® HP3610 from PPG Industries Fiber Glass in a Leistritz ZSE 27 MAXX 48D twin-screw extruder at 280° C. with a throughput of 20 kg/h. The following compounds were produced:

TABLE 11

| | Novadyn ™ | FiberglassChopVantage ® | | | |
|---|---|---|---|---|---|
| | DT/DI | HP3610 | Additive 2 | Additive 4 | Additive 5 |
| | [% by weight] | [% by weight] | [% by weight] | [% by weight] | [% by weight] |
| R41 | 70 | 30 | | | |
| R42 | 67.9 | 30 | 2.1 | | |
| R43 | 67.9 | 30 | | 2.1 | |
| R44 | 67.9 | 30 | | | 2.1 |

The mass pressure, torque of the extruder and the viscosity of the compounds on the test specimens were investigated. These results are shown in Table 12 together with the length of the flow spiral. Furthermore, the mechanical characteristics were determined and summarized in Table 13.

TABLE 12

| | | Mass | | Spiral |
|---|---|---|---|---|
| | Torque | pressure | Relative | length |
| | [%] | [bar] | viscosity | [cm] (%) |
| R41 | 70 | 24 | 2.04 | 43.90 |
| R42 | 57 | 21 | 2.03 | 50.55 |
| R43 | 49 | 16 | 1.99 | 51.85 |
| R44 | 50 | 18 | 1.99 | 52.00 |

Due to its low initial viscosity and its low water content during compounding, the partially aromatic polyamide used leads to a build-up of the polymer chains by polycondensation, as shown by the viscosity increase in variant R41. It can be assumed that this reaction competes with the targeted degradation by the inventive additives. The relative viscosities of the variants R42, R43 and R44 measured after compounding result from the combination of these opposing effects.

Furthermore, it is shown that the use of aromatic terephthalic acid (additives 4 and 5) has a stronger influence on the viscosity adjustment and a better flowability (longer flow spirals) than the use of adipic acid as acid component (additive 2), even though the molar acid concentration is 12% higher with the use of adipic acid. The processability on the extruder is also improved when terephthalic acid is used.

The additional use of the reactive polymer polybutylene terephthalate in additive 5 has practically no effect on the performance of the additive. The processing properties, the length of the flow spiral and the mechanical properties are at the same level (as without additional PBT).

Here it can be seen that by using additives according to the invention, a targeted viscosity adjustment and a targeted adjustment of the flowability is also possible with partially aromatic polyamides, while at the same time maintaining the mechanical characteristic values.

TABLE 13

| | | | | notched |
|---|---|---|---|---|
| | tensile | Elongation | modulus of | bar impact |
| | strength | at break | elasticity | strength |
| | [MPa] | [%] | [MPa] | kJ/m2 |
| R41 | 217 | 6 | 10.300 | 9.44 |
| R42 | 215 | 6.2 | 10.200 | 9.17 |
| R43 | 213 | 6.1 | 10.100 | 9.10 |
| R44 | 210 | 6 | 10.400 | 8.61 |

### Example 8

Additive 2 was extruded with polyamide 6 (Alphalon 32 from Grupa Azoty) and glass fibres as well as with the additional additives listed in Table 14 in a Leistritz ZSE 27 MAXX 48D twin-screw extruder at 260° C. with a throughput of 20 kg/h. The relevant characteristics have been determined and are summarised in Table 14. This shows that the effectiveness of the additive according to the invention is not impaired by the presence of other additives. Surprisingly, in certain combinations the product properties of the modified polyamide show further improvement. This is clearly shown by the almost unchanged values for the spiral length in the examples R46 to R48, while other properties can be specifically improved. The addition of the montanic acid ester to R46, for example, results in better processability and higher notched bar impact strength. The addition of calcium montanate in R47 increases the values for modulus of elasticity and gloss, while the addition of a phthalamide-based additive in R48 brings no further improvement. These results are unexpected since the conventional additives of the examples R46 and R47 are known as lubricants but not to increase mechanical properties. This unexpected synergistic effect with the additive according to the invention shows that an unexpected but targeted modification of the properties of polyamides is possible with the present invention. Example R48 shows that the inventive system also shows the desired activity when using a further additive at the same time (which is widely used especially in fiber production).

Particularly preferred is the simultaneous use of the additive according to the invention together with a polyhydric alcohol (in the examples R49 to R51). Surprisingly, the flowability is further improved while maintaining the mechanical property profile, without the relative viscosity being further reduced by the additional polyhydric alcohol. Polyhydric alcohols such as dipentarythritol have so far been used primarily as additives in flame retardants and to stabilize reinforced polyamides at high operating temperatures.

Even with a high polyhydric alcohol content of 3% in example R51, the relative viscosity of the polyamide modified according to the invention is only slightly reduced and the mechanical properties are retained, while the flowability is further significantly increased. The use of an additive in keeping with the invention can also result in high temperature-stabilized polyamides, which at the same time exhibit very good processability and high flowability.

TABLE 14

| | | | Fiber glass | | | | | | | |
|---|---|---|---|---|---|---|---|---|---|---|
| | Polyamide | Additive | ChopVantage ® | Additional | | | | Notch | | |
| | 6 | 2 | HP3610 | additive | Relative | Spiral | Torque | impact | modulus of | |
| | [% by | [% by | [% by | [% by | viscosity | length | extruder | strength | elasticity | gloss |
| | weight] | weight] | weight] | weight] | compound | [cm] | [%] | [kJ/m²] | [MPa] | [60°] |
| R45 | 68.60 | 1.4 | 30 | — | 2.59 | 47.70 | 55 | 14.01 | 9550 | 85.7 |
| R46 | 67.90 | 1.4 | 30 | 0.70% | 2.61 | 47.55 | 50 | 18.86 | 9590 | 86.2 |
| | | | | Montanoic acid | | | | | | |
| | | | | esters with | | | | | | |
| | | | | multifunctional | | | | | | |
| | | | | alcohols | | | | | | |
| R47 | 68.25 | 1.4 | 30 | 0.35% | 2.64 | 46.45 | 52 | 14.09 | 9770 | 88.5 |
| | | | | calcium | | | | | | |
| | | | | montanate | | | | | | |
| R48 | 68.25 | 1.4 | 30 | 0.35% | 2.61 | 47.65 | 55 | 13.91 | 9610 | 83.7 |
| | | | | N,N′-bis(2,2,6,6- | | | | | | |
| | | | | tetramethyl-4- | | | | | | |
| | | | | piperidyl)iso- | | | | | | |
| | | | | phthalamide | | | | | | |
| R49 | 68.25 | 1.4 | 30 | 0.35% | 2.59 | 48.00 | 54 | 13.20 | 9620 | 84.9 |
| | | | | Dipentaerythritol | | | | | | |
| | | | | (2,2- | | | | | | |
| | | | | bis(hydroxymethyl)pro- | | | | | | |
| | | | | pane-1,3-diol) | | | | | | |
| R50 | 67.90 | 1.4 | 30 | 0.70% | 2.60 | 48.15 | 53 | 13.97 | 9670 | 86.1 |
| | | | | dipentaerythritol | | | | | | |
| | | | | (2,2- | | | | | | |
| | | | | bis(hydroxymethyl)pro- | | | | | | |
| | | | | pane-1,3-diol) | | | | | | |
| R51 | 65.60 | 1.4 | 30 | 3.00% | 2.56 | 50.60 | 50 | — | 9680 | — |
| | | | | Dipentaerythritol | | | | | | |
| | | | | (2,2- | | | | | | |
| | | | | bis(hydroxymethyl)pro- | | | | | | |
| | | | | pane-1,3-diol) | | | | | | |

### Example 9

Heat ageing tests were carried out to check the stability of polyamides modified in accordance with the invention.

A polyamide 6.6 (Ultramid® A27 E from BASF) was compounded with two different heat stabilizers, each with and without additive 2, in a Leistritz twin-screw extruder (ZSE27MAXX—48D) with a throughput of 15 kg/h and injection-molded into tensile test specimens. After heat aging, the time to retention of 50% of the initial strength was determined. The values are shown in Tables 15 and 16.

TABLE 15
Stabilization of polyamide 6.6 modified according to invention
with a combination of a hindered phenolic antioxidant and a
phosphite; Heat aging at 130° C.
Polyamide 6.6 natural was processed once with additive 2 and once
without (comparative variant), and both variants were stabilized
with the combination of a hindered phenolic antioxidant (AO-7)
and a phosphite (PS-2). Primary phenolic antioxidant AO-7, CAS
No. 23128-74-7, N,N′-hexane-1,6-diylbis[3-(3,5-di-tert.-
butyl-4-hydroxyphenyl)propionamide]; Secondary phosphitic
antioxidant PS-2, CAS No. 31570-04-4, tris(2,4-ditert-butyl-
phenyl)phosphite; The heat aging took place at 130° C.

| | | Time to retention of |
|---|---|---|
| | | 50% of initial tensile |
| type | Composition | strength |
| According | Polyamide 6.6 modified with | 1.900 h |
| to invention | 3% Additive 2 and with | |
| | 0.25% AO-7/0.25% PS-2 | |
| comparative | Polyamide 6.6 with | 1.800 h |
| | 0.25% AO-7/0.25% PS-2 | |

TABLE 16
Stabilization of polyamide 6.6 modified according to
invention with a combination of copper iodide and
potassium bromide; Heat aging at 180° C.
Polyamide 6.6 was processed once with additive 2 and once
without (comparative variant), and both variants were stabilized
with the combination of copper iodide and potassium bromide.
The heat aging took place at 180° C.

| | | Time to retention of |
|---|---|---|
| | | 50% of initial tensile |
| type | Composition of the | strength |
| According | Polyamide 6.6 modified with | 480 h |
| to invention | 3% Additive 2 and with 0.03% CuI | |
| | and 0.14% KBr | |
| compromise | Polyamide 6.6 with | 500 h |
| | 0.03% CuI and 0.14% KBr | |

Tables 15 and 16 show that the viscosity adjustment with additive 2 does not reduce the stability of the polyamide. Regardless of the type of heat stabilizer used, no influence could be found on the maintenance of the tensile strength after heat aging and thus on the effectiveness of the respective stabilizer. Neither when using a combination of a hindered phenolic antioxidant and a phosphite, nor when using a copper salt together with an alkali halide (classical copper-based stabilization), does the time to retention of 50% of the initial tensile strength change significantly by the inventional viscosity adjustment. This is particularly noteworthy as relatively large amounts of additive were used in these tests in accordance with the invention at hand. This shows that the inventive system has no detrimental effect on other functional components such as heat stabilizers.

### Example 10

A commercial partially aromatic polyamide, PA6T/61/66 with 50% glass fiber content for injection molding, was mixed together with Additive 2 and Additive 4 in granulate form and these mixtures were processed directly by injection molding into flow spirals, impact test specimens and tensile test specimens. The results were compared to the direct processing of the same polyamide without additive. The melt temperature was 290° C., the mould temperature 90° C. and the injection speed 240 mm/s. The length of the flow spiral was measured in cm and the relative viscosity was determined on the material of the flow spiral. Table 17 summarizes the compositions and Table 18 the measured values.

TABLE 17

| | PA6T/6I/66 | | |
|---|---|---|---|
| | with 50% glass | | |
| | fiber content | Additive 2 | Additive 4 |
| | [% by weight] | [% by weight] | [% by weight] |
| R52 | 100 | | |
| R53 | 98.5 | 1.5 | |
| R54 | 98.5 | | 1.5 |

TABLE 18

| | | | | | | Notched bar |
|---|---|---|---|---|---|---|
| | | | tensile | Elongation at | modulus of | impact |
| | Relative | spiral length | strength | break | elasticity | toughness |
| | viscosity | cm] (%) | [MPa] | [%] | [MPa] | kJ/m2 |
| R52 | 2.75 | 44.50 (100.00) | 252.2 | 3.1 | 16.197 | 17.00 |
| R53 | 2.72 | 46.42 (104.31) | 234.7 | 2.8 | 15.372 | 15.94 |
| R54 | 2.68 | 53.95 (121.23) | 226.2 | 2.8 | 14.735 | 16.14 |

With both additives, which were in line with the invention, a targeted adjustment of the viscosity and a significant improvement of the flowability (length of the flow spiral) could also be achieved when used as a granulate mixture with the polyamide to be modified in direct injection moulding. It can be seen here that using the inventive additive 4 with an aromatic dicarboxylic acid (in this case terephthalic acid) yields significantly better results than using the inventive additive 2 based on an aliphatic dicarboxylic acid (in this case adipic acid). The very good mechanical property profile of the highly filled partially aromatic polyamide remains almost unchanged.

### Example 11

Additive 4 and Additive 5 were compounded together with the nucleating agent Bruggolen P252 from Bruggemann and with the commercial polyethylene terephthalate PET 4048 from INVISTA and with the glass fibre ChopVantage® HP3786 from PPG Industries Fiber Glass in a Leistritz ZSE 27 MAXX 48D twin-screw extruder at 280° C. with a throughput of 20 kg/h and then injection-molded to tensile test specimens and impact tensile specimens.

Table 19 summarizes the compositions and Table 20 the measured mechanical values. The length of the flow spiral was measured in cm and the intrinsic viscosity was measured on the compound.

TABLE 19

| | | | | | nucleating |
|---|---|---|---|---|---|
| | PET | Additive 4 | Additive 5 | Glass fiber | agent |
| | [% by | [% by | [% by | [% by | [% by |
| | weight] | weight] | weight] | weight] | weight] |
| R55 | 69.5 | | | 30 | 0.5 |
| R56 | 68.8 | 0.70 | | 30 | 0.5 |
| R57 | 68.45 | 1.05 | | 30 | 0.5 |
| R58 | 68.8 | | 0.70 | 30 | 0.5 |
| R59 | 68.45 | | 1.05 | 30 | 0.5 |

TABLE 20

| | | | | | | Notched bar |
|---|---|---|---|---|---|---|
| | | | tensile | Elongation at | modulus of | impact |
| | Intrinsic | spiral length | strength | break | elasticity | toughness |
| | viscosity | cm] (%) | [MPa] | [%] | [MPa] | kJ/m2 |
| R55 | 0.598 | 48.45 (100.00) | 157 | 4.6 | 10.300 | 11.73 |
| R56 | 0.560 | 53.80 (110.42) | 177 | 4.7 | 11.100 | 10.12 |
| R57 | 0.543 | 55.05 (113.62) | 178 | 4.6 | 11.200 | 10.27 |
| R58 | 0.559 | 54.25 (111.97) | 177 | 4.7 | 11.000 | 9.97 |
| R59 | 0.545 | 55.20 (113.93) | 178 | 4.6 | 11.100 | 10.46 |

With both additives 4 and 5, which were in line with the invention, it was thus surprising to see that even with polyethylene terephthalate (PET) a targeted adjustment of viscosity and a significant improvement in flowability (length of the flow spiral) could be achieved without a drop in the mechanical characteristic values. The additional use of the reactive polymer polybutylene terephthalate in the production of additive 5 has no effect on the performance of additive 5 in PET. The length of the flow spiral and the mechanical characteristics remain at the same level. These examples make it clear that the effect of the present invention, which has been experimentally proven especially for polyamides, can also be transferred to other polycondensates, especially polyesters.

1. Additive for the controlled modification (viscosity adjustment) of polymers having acid cleavable units, in particular polycondensates such as polyamides, polyesters, polycarbonates and polyethers, and copolymers thereof, comprising:
an acid and/or acid anhydride or mixtures thereof and
a carrier,
characterized in that the acid and/or the acid anhydride or mixtures thereof are uniformly distributed in the carrier and the carrier does not react with the acid or the acid anhydride.

2. Additive according to claim 1, characterized in that the acid and/or the acid anhydride is a carboxylic acid or carboxylic anhydride.

3. Additive according to claim 2, characterized in that the carboxylic acid is a polyfunctional carboxylic acid.

4. An additive according to claim 3, characterized in that the polyfunctional carboxylic acid is a bifunctional carboxylic acid.

5. An additive according to any of claims 1 to 4, characterized in that the acid is selected from the group consisting of adipic acid, pimelic acid, cork acid, azelaic acid, sebacic acid, undecandicarboxylic acid, dodecandicarboxylic acid, oxalic acid, malonic acid, Succinic acid, glutaric acid, oxalacetic acid, phthalic acid, terephthalic acid, isophthalic acid, 2-(10Oxo-10H-9-oxa-10-phosphaphenantren-10-ylmethyl)succinic acid or mixtures thereof, particularly adipic acid, sebacic acid and terephthalic acid.

6. An additive according to any of claim 1 or 2, characterized in that the acid anhydride is selected from trimellitic anhydride, succinic anhydride, phthalic anhydride or mixtures thereof.

7. An additive according to one of claim 1 or 2, characterized in that the acid is an acid-terminated polymer or oligomer, preferably selected from polyamides, oligoamides and polyesters and mixtures thereof, in particular acid-terminated oligomeric amides and acid-terminated polyamide 6, polyamide 6.6, PBT and PET and mixtures of said polymers or mixtures of said polymers and said oligomers.

8. An additive according to any of claims 1 to 7, characterized in that the carrier is a polymeric carrier, preferably selected from a polymer or copolymer of the monomers ethylene, polypropylene or other olefins, methacrylic acid, vinyl acetate, acrylic acid, acrylic acid ester, or methacrylic acid ester, in particular preferably an olefin-acrylic acid ester copolymer or an olefin-methacrylic acid ester copolymer, in particular an ethylene-methyl acrylate copolymer (EMA), an ethylene-ethyl acrylate copolymer (EEA) or an ethylene-butyl acrylate copolymer (EBA).

9. Additive according to one of claims 1 to 8, characterized in that the acid and/or the acid anhydride is present in an amount of 1 to 50% by weight, preferably 5 to 33% by weight, in particular 8 to 30% by weight, based on the total amount of the additive.

10. An additive according to any of claims 1 to 9, further comprising at least one additive selected from the group consisting of antioxidants, nucleating agents, stabilizers, lubricants, mold release agents, lubricity improvers, fillers, colorants, flame retardants and flame protective agents, plasticizers, impact modifiers, antistatic agents, processing aids, and polyhydric alcohols as well as their ether or ester derivatives and further polymers usually compounded with polyamides or mixtures thereof.

11. Additive according to one of the above claims, further comprising a polymeric material reactive with the acid and/or the acid anhydride, in particular a polyamide, such as polyamide 6 and polyamide 6.6, and mixtures thereof, and/or a polyester, such as PET and PBT, and mixtures thereof, or mixtures thereof of polyamides and polyesters, and/or wherein the proportion of reactive polymeric material, based on the total composition of the additive, is 50% by weight or less and preferably not higher than the proportion of non-reactive carrier.

12. A process for preparing the additive according to any one of claims 1 to 11 which comprises introducing the acid or acid anhydride and optionally further ingredients into the carrier in the melt and uniformly distributing the acid and/or acid anhydride in the carrier.

13. Process for the controlled viscosity adjustment of polymers having acid-cleavable units, in particular polycondensates such as polyamides, polyesters, polycarbonates and polyethers and copolymers thereof, comprising mixing the additive according to claims 1 to 11 with the polymer concerned in the melt or melting together a mixture of the additive and the polymer concerned.

14. Use of the additive according to one of claims 1 to 11 for the controlled viscosity adjustment of polymers which have acid-cleavable units, in particular polycondensates, such as polyamides, polyesters, polycarbonates and polyethers, and copolymers thereof.

15. Process according to claim 13 or use according to claim 14, characterized in that the polymer is a polyamide selected from reinforced or unreinforced aliphatic polyamides such as PA 6, PA 6.6, PA 4.6, PA 11, PA 12 or from corresponding copolyamides or from mixtures of different polyamides or copolyamides, or an unreinforced or reinforced aliphatic polyester.

16. Process according to claim 13 or use according to claim 14, characterized in that the polymer is a polyamide selected from reinforced or unreinforced partially aromatic polyamides in which the monomers are partly derived from aromatic basic bodies or from corresponding copolyamides or from mixtures of partially aromatic polyamides or copolyamides with one another and/or with aliphatic polyamides or copolyamides, or an unreinforced or reinforced aromatic or partially aromatic polyester, preferably PET or PBT.

17. A process according to any of claim 13, 15 or 16 or use according to any of claims 14 to 16, wherein the additive is used in the injection molding of polyamides.
